(19) United States
(12) Patent Application Publication
(10) Pub. No.: US 2016/0307431 A1
(43) Pub. Date: Oct. 20, 2016

(54) BABY SEAT ALERT

(71) Applicant: Orlando Allen, SR., Palmyra, VA (US)

(72) Inventor: Orlando Allen, SR., Palmyra, VA (US)

(21) Appl. No.: 14/689,185

(22) Filed: Apr. 17, 2015

(51) Int. Cl. G08B 21/24; B60N 2/00; B60N 2/26; G07C 5/00

(52) U.S. Cl. CPC G08B 21/24; G07C 5/008; B60N 2/002; B60N 2/26

(57) ABSTRACT

An alert system for use with a infant car seat that includes: a car seat alert device, where the alert device includes a means to attach the alert device to a car seat, a belt extending from the means to attach and an activation button on the alert device; software residing on a user's smartphone, where the software links the user's smartphone to the alert device; and instructions within the software activating an alert on the smartphone, if the smartphone is moved greater than a predetermined distance from the car seat. The car seat device may also be linked to a vehicle's computer system, where the car seat device sends a secondary alert to the vehicle's computer system. The secondary alert activates a horn or light system of the vehicle. The alert system may further include a central monitoring system remotely connected to the user's smartphone.

### BACKGROUND OF THE INVENTION

1. Field of Invention

The present invention relates to a device that is engaged with an infant car seat that provides an electronic alert to a user's handheld device.

2. Description of Related Art

Many times each year stories are released in the news related to infants accidentally left in a vehicle by their parent or guardian. As recognized, many infants and children sit in car seats in the rear seats of a vehicle. Many times parents or guardians who may be operating the vehicle may be overwhelmed with tasks and duties and accidentally forget that their infant is in the car seat. This situation is particularly conceivable due to the wide use of cell phones while driving and the various engaging with cell phones that are used by individuals. The danger of leaving an infant or child in a car seat unattended is a possible occurrence. If an infant is left in an unattended vehicle, the infant may suffer physical harm due to conditions within the vehicle depending on the outdoor environment whether it is cold or hot outside. Further, the infant may be easily kidnapped if left unattended in the vehicle. Further, the vehicle may be stolen while the child is in the car seat. In certain instances, individuals have stolen vehicles not even knowing that a child was within a car seat in the rear of the vehicle. So in order to avoid such danger it would be advantageous to have a system developed that could alert the parent or guardian that a child is being left in a car seat within seconds of stepping away from the vehicle.

### SUMMARY OF THE INVENTION

The present invention relates to an alert system for use with a infant car seat that includes: a car seat alert device, where the alert device includes a means to attach the alert device to a car seat, a belt extending from the means to attach and an activation button on the alert device; software residing on a user's smartphone, where the software links the user's smartphone to the alert device; and instructions within the software activating an alert on the smartphone, if the smartphone is moved greater than a predetermined distance from the car seat. The car seat device may also be linked to a vehicle's computer system, where the car seat device sends a secondary alert to the vehicle's computer system. The secondary alert activates a horn or light system of the vehicle. The alert system may further include a central monitoring system remotely connected to the user's smartphone.

### BRIEF DESCRIPTION OF DRAWINGS

FIG. 1 depicts a device used in conjunction with a cell phone application to alert a parent or a guardian of the presence of a child in a car seat.

### DETAILED DESCRIPTION

The present invention relates to a device and system that is used to alert a parent or guardian if a child is being left within a car seat. The present invention attaches to the car seat through an attachment means provided. The device includes a sensor that detects the presence of a child within a car seat. Once a child is within a car seat a signal is connected to a linked smart phone application stored within a user's smart phone. This link is maintained until the child is removed from the car seat. The software within the smart phone detects a predetermined distance between the smart phone and car seat and upon movement beyond this predetermined range an alert is immediately activated on the smart phone. This alert provides the user with an indication that the child has been unintentionally left within a car seat. Further the software within the application includes further features to assist an abandoned child within a car seat. After the first alert is provided upon an expiration of predetermined time a call is placed to a central monitoring system. This central monitoring system receives the alert and therefore provides a means to contact emergency personnel that may be needed to remove the child from the vehicle. This timing period could be up to 2 to 5 minutes. In a further embodiment, the system may include a secondary backup system that is configured with the vehicle's computer therefore providing an alert in the form of an activating of the vehicle's horn and/or lights to further bring attention to the vehicle and the fact that the child has been left in the vehicle.

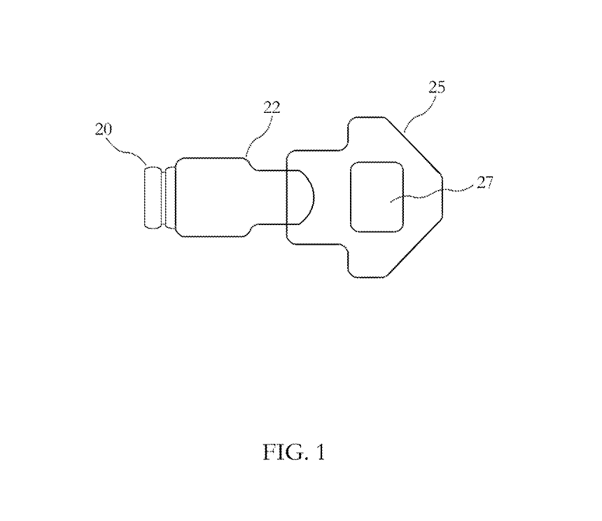

In reference to FIG. 1, car seat alert device 25 is depicted. The alert device 25 includes an attachment latch 20 that is used to attach the device 25 to a car seat. Belt 22 is connected to the attachment latch 20 at a first end and at the opposing end, the alert device 25 is provided. The alert device 25 includes activation button 27. The activation button 27 activates the device 25, which includes a sensor to detect the presence of the child in the car seat.

Working in conjunction with the device 25 is software that is installed on the smart phone of a user. This smart phone software is activated upon receiving a signal from the alert device 25. Upon receipt of the signal, a link is provided between the smart phone and alert device 25. The software then receives an alert if the user should move a predetermined distance away from the car seat. As an alternative should the user ignore or is not aware of the alert sent to the smart phone, the smart phone may then send an alert to a central monitoring system or location where a remote operator may receive an alert of the child in the car seat at the location provided based upon the locating tracking system of the smart phone. Further through a registration process related to the software application, the remote operator will be able to detect the user I.D. information which should identify the vehicle information in order for third party rescue personnel to locate and save the child.

As an alternative system the locating device 25 may also be linked with software within the vehicle computer so that the vehicle produces an alert in the form of horn blowing and/or light flashing as a result of the child being left in the vehicle. The instant invention has been shown and described in what it considers to be the most practical and preferred embodiments. It is recognized, however, that departures may be made there from within the scope of the invention and that obvious modifications will occur to a person skilled in the art.

1. An alert system for use with a infant car seat comprising:
a. a car seat alert device, where the alert device includes an attachment latch, where the attachment latch is adapted to attach the alert device to a car seat, a belt extending from the attachment latch and an activation button on the alert device;
b. a sensor within the alert device, wherein said sensor is adapted to detect the presence of a child in the car seat;
c. software residing on a user's smartphone, where the software links the user's smartphone to the alert device; and
d. instructions within the software activating an alert on the smartphone, if the smartphone is moved greater than a predetermined distance from the car seat.

2. The alert system according to claim 1, where the car seat device is also linked to a vehicle's computer system.

3. The alert system according to claim 2, where the car seat device sends an secondary alert to the vehicle's computer system.

4. The alert system according to claim 3, where the secondary alert activates a horn or light system of the vehicle.

5. The alert system according to claim 1, further including a central monitoring system remotely connected to the user's smartphone.
